(19) United States
(12) Patent Application Publication
(10) Pub. No.: US 2018/0295680 A1
(43) Pub. Date: Oct. 11, 2018

(54) CONTROL METHOD AND CONTROL DEVICE FOR MICROWAVE OVEN

(71) Applicants: GUANGDONG MIDEA KITCHEN APPLIANCES MANUFACTURING CO., LTD., Foshan (CN); MIDEA GROUP CO., LTD., Foshan (CN)

(72) Inventors: Hyo Keun LEE, Foshan (CN); Bin Tang, Foshan (CN)

(21) Appl. No.: 16/005,668

(22) Filed: Jun. 11, 2018

Related U.S. Application Data
(63) Continuation of application No. PCT/CN2016/086963, filed on Jun. 23, 2016.

(30) Foreign Application Priority Data
Dec. 16, 2015 (CN) 201510952254.8

(51) Int. Cl. H05B 6/68; H05B 6/64

(52) U.S. Cl. CPC H05B 6/687; H05B 6/6473

(57) ABSTRACT

The present disclosure provides a control method and a control device for a microwave oven. The microwave oven includes an enamel cavity, a hot air convection heating pipe and a baking heating pipe for heating the enamel cavity, and a temperature sensor for detecting the temperature in the enamel cavity. The control method for the microwave oven includes detecting the temperature in the enamel cavity by the temperature sensor, and according to a relationship between the temperature in the enamel cavity and a predetermined temperature, controlling the operation and closing of the hot air convection heating pipe and the baking heating pipe, controlling the baking heating pipe to work at a predetermined period during the operation, and controlling the working time of the baking heating pipe within each period.

### CROSS-REFERENCE TO RELATED APPLICATION

The present application is a continuation of International Application PCT/CN2016/086963, filed Jun. 23, 2016, which claims the priority of Chinese Patent Application No. 201510952254.8, filed in the Chinese Patent Office on Dec. 16, 2015, and entitled “CONTROL METHOD AND CONTROL DEVICE FOR MICROWAVE OVEN”,

### FIELD

The present disclosure relates to the technical field of microwave ovens, and particularly relates to a control method for a microwave oven and a control device for the microwave oven.

### BACKGROUND

Currently, the existing microwave ovens having composite functions (hot air convection and baking functions) have cavities made of stainless steel and epoxy coating. With the development of the microwave oven technology, microwave ovens with enamel cavities have gradually emerged. The enamel cavities are easy to clean, so that they have been highly praised by consumers for their use in microwave ovens. The difference of the enamel-coated cavities with the cavities made of the stainless steel and the epoxy coating lies in the inherent heat preservation characteristic of the enamel.

In order to increase the center temperature in the cavity of the microwave oven, during the single heating of a hot air convection heating pipe, the surface temperature of a stainless steel outer cover continues to rise due to the continuous heat conduction of the hot air and the enamel coating, and the surface temperature of the microwave oven does not drop immediately due to the heat preservation characteristic of the enamel when heating is stopped. In other words, due to the inherent heat preservation characteristic of the enamel coating, the reheating for improving the enamel-preserved heat and the center temperature leads to an over high surface temperature of the stainless steel outer cover, such that the surface temperature of the microwave oven does not meet the requirements of the temperature standard.

Therefore, how to effectively control the surface temperature of the enamel cavity microwave oven having the composite functions becomes a technical problem to be solved urgently.

### SUMMARY

The present disclosure is to provide a novel microwave oven control solution that achieves effective control on the surface temperature of an enamel cavity microwave oven having composite functions.

Embodiments of the present disclosure provides a control method for a microwave oven, the microwave oven includes an enamel cavity, a hot air convection heating pipe and a baking heating pipe used for heating the enamel cavity, and a temperature sensor used for detecting the temperature in the enamel cavity, the control method for the microwave oven includes: detecting the temperature in the enamel cavity by the temperature sensor; and according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling the working time of the baking heating pipe within each period.

In the control method for the microwave oven according to the embodiment of the present disclosure, for the enamel cavity microwave oven having composite functions (i.e., a hot air convection function and a baking function), by detecting the temperature in the enamel cavity, and according to the relationship between the temperature in the enamel cavity and the predetermined temperature, by controlling the operation and closing of the hot air convection heating pipe and the baking heating pipe, controlling the baking heating pipe to work at the predetermined period during the operation, and controlling the working time of the baking heating pipe within each period, on the premise of guaranteeing that the center temperature in the cavity of the microwave oven can be quickly raised, the problem that excessive temperature rise in the cavity leads to an over high surface temperature of an outer cover of the microwave oven is avoided, and effective control on the surface temperature of the enamel cavity microwave oven having the composite functions is achieved.

The control method for the microwave oven according to the above embodiment of the present disclosure can further have the following technical features:

according to one embodiment of the present disclosure, the step of controlling the operation and closing of the hot air convection heating pipe and the baking heating pipe, controlling the baking heating pipe to work at the predetermined period during the operation, and controlling the working time of the baking heating pipe within each period, includes: when an instruction of starting the microwave oven is received, controlling the hot air convection heating pipe and the baking heating pipe to operate, and controlling the baking heating pipe to work for a first predetermined time length within each period; and when the temperature in the enamel cavity reaches a difference between the predetermined temperature and a first set value, controlling the hot air convection heating pipe and the baking heating pipe to close.

In the control method for the microwave oven according to the embodiment of the present disclosure, when the microwave oven is just started (i.e., when the instruction of starting the microwave oven is received), the hot air convection heating pipe and the baking heating pipe are controlled to operate and the baking heating pipe is controlled to work for the first predetermined time length within each period, and when the temperature in the enamel cavity reaches the difference between the predetermined temperature and the first set value, the hot air convection heating pipe and the baking heating pipe are controlled to close, in this way, when the temperature in the cavity of the microwave oven reaches the predetermined temperature, the heating can be closed in time to avoid unnecessary temperature rise in the cavity so as to effectively control the surface temperature of the outer cover of the microwave oven. After the hot air convection heating pipe and the baking heating pipe are controlled to close, the temperature in the enamel cavity of the microwave oven firstly rises and then drops.

According to one embodiment of the present disclosure, after controlling the hot air convection heating pipe and the baking heating pipe to close, the method further includes: when the temperature in the enamel cavity is lower than a difference between the predetermined temperature and a second set value, controlling the hot air convection heating pipe and the baking heating pipe to operate, and controlling the baking heating pipe to work for a second predetermined time length within each period, and the second predetermined time length is shorter than the first predetermined time length.

In the control method for the microwave oven according to the embodiment of the present disclosure, after the hot air convection heating pipe and the baking heating pipe are controlled to close, when the temperature in the enamel cavity is lower than the difference between the predetermined temperature and the second set value, the hot air convection heating pipe and the baking heating pipe are controlled to operate, and the baking heating pipe is controlled to work for the second predetermined time length within each period, and the second predetermined time length is shorter than the first predetermined time length, in this way, after the temperature in the enamel cavity drops, the temperature in the enamel cavity can be slowly increased (since the temperature at the moment is close to the predetermined temperature) so as to effectively control the surface temperature of the outer cover of the microwave oven and avoid the problem that the temperature of the outer cover of the microwave oven is difficult to control due to the over fast temperature rise in the enamel cavity.

According to one embodiment of the present disclosure, after controlling the hot air convection heating pipe and the baking heating pipe to operate, and controlling the baking heating pipe to work for the second predetermined time length within each period, the method further includes: if a cooking process is not ended,

when the temperature in the enamel cavity reaches a sum of the predetermined temperature and a third set value, controlling the hot air convection heating pipe and the baking heating pipe to close; and when the temperature in the enamel cavity is lower a the difference between the predetermined temperature and a fourth set value, controlling the hot air convection heating pipe and the baking heating pipe to operate, and controlling the baking heating pipe to work for a third predetermined time length within each period.

In the control method for the microwave oven according to the embodiment of the present disclosure, after the baking heating pipe is controlled to work for the second predetermined time length within each period, if the temperature in the enamel cavity reaches the sum of the predetermined temperature and the third set value, the hot air convection heating pipe and the baking heating pipe are controlled to close; and if the temperature in the enamel cavity is lower than the difference between the predetermined temperature and the fourth set value, the hot air convection heating pipe and the baking heating pipe are controlled to operate, and the baking heating pipe is controlled to work for the third predetermined time length within each period, in this way, when the cooking process is not ended, the temperature in the enamel cavity can be controlled within a certain range in order to indirectly control the temperature of the outer cover of the microwave oven within the range required by the temperature standard, and thus the effective control on the temperature of the outer cover of the microwave oven is achieved.

If an instruction indicating cooking ending is received or when the cooking program is ended, it is determined that the cooking process is ended; and if the instruction indicating cooking ending is not received, and when the cooking program is not ended, it is determined that the cooking process is not ended.

According to one embodiment of the present disclosure, the first predetermined time length accounts for 40% to 60% of the predetermined period, the second predetermined time length accounts for 20% to 40% of the predetermined period, and the third predetermined time length accounts for 20% to 40% of the predetermined period; and

the first set value is 5° C. to 10° C., the second set value is 6° C. to 11° C., the third set value is 5° C. to 8° C., and the fourth set value is 2° C. to 5° C.

According to one embodiment of the present disclosure, the predetermined period of the baking heating pipe during the operation is 10 s to 20 s.

An embodiment of the present disclosure provides a control device for a microwave oven, the microwave oven includes an enamel cavity, a hot air convection heating pipe and a baking heating pipe used for heating the enamel cavity, and a temperature sensor used for detecting the temperature in the enamel cavity, the control device for the microwave oven includes: a detection device used for detecting the temperature in the enamel cavity by the temperature sensor; and a control device used for, according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling a working time of the baking heating pipe within each period.

In the control device for the microwave oven according to the embodiment of the present disclosure, for the enamel cavity microwave oven having composite functions (i.e., a hot air convection function and a baking function), by detecting the temperature in the enamel cavity, and according to the relationship between the temperature in the enamel cavity and the predetermined temperature, by controlling the operation and closing of the hot air convection heating pipe and the baking heating pipe, controlling the baking heating pipe to work at the predetermined period during the operation, and controlling the working time of the baking heating pipe within each period, on the premise of guaranteeing that the center temperature in the cavity of the microwave oven can be quickly raised, the problem that excessive temperature rise in the cavity leads to an over high surface temperature of an outer cover of the microwave oven is avoided, and effective control on the surface temperature of the enamel cavity microwave oven having the composite functions is achieved.

The control device for the microwave oven according to the above embodiment of the present disclosure can further have the following technical features:

According to one embodiment of the present disclosure, the control device is used for: when an instruction of starting the microwave oven is received, controlling the hot air convection heating pipe and the baking heating pipe to operate, and controlling the baking heating pipe to work for a first predetermined time length within each period, and when the detection device detects that the temperature in the enamel cavity reaches a difference between the predetermined temperature and a first set value, controlling the hot air convection heating pipe and the baking heating pipe to close.

In the control device for the microwave oven according to the embodiment of the present disclosure, when the microwave oven is just started (i.e., when the instruction of starting the microwave oven is received), the hot air convection heating pipe and the baking heating pipe are controlled to operate and the baking heating pipe is controlled to work for the first predetermined time length within each period, and when the temperature in the enamel cavity reaches the difference between the predetermined temperature and the first set value, the hot air convection heating pipe and the baking heating pipe are controlled to close, in this way, when the temperature in the cavity of the microwave oven reaches the predetermined temperature, the heating can be closed in time to avoid unnecessary temperature rise in the cavity so as to effectively control the surface temperature of the outer cover of the microwave oven. After the hot air convection heating pipe and the baking heating pipe are controlled to close, the temperature in the enamel cavity microwave oven firstly rises and then drops.

According to one embodiment of the present disclosure, after controlling the hot air convection heating pipe and the baking heating pipe to close, the control device is further used for: when the detection device detects that the temperature in the enamel cavity is lower than a difference between the predetermined temperature and a second set value, controlling the hot air convection heating pipe and the baking heating pipe to operate, and controlling the baking heating pipe to work for a second predetermined time length within each period, and the second predetermined time length is shorter than the first predetermined time length.

In the control device for the microwave oven according to the embodiment of the present disclosure, after the hot air convection heating pipe and the baking heating pipe are controlled to close, when the temperature in the enamel cavity is lower than the difference between the predetermined temperature and the second set value, the hot air convection heating pipe and the baking heating pipe are controlled to operate, and the baking heating pipe is controlled to work for the second predetermined time length within each period, and the second predetermined time length is shorter than the first predetermined time length, in this way, after the temperature in the enamel cavity drops, the temperature in the enamel cavity can be slowly increased (since the temperature at the moment is close to the predetermined temperature) so as to effectively control the surface temperature of the outer cover of the microwave oven and avoid the problem that the temperature of the outer cover of the microwave oven is difficult to control due to the over fast temperature rise in the enamel cavity.

According to one embodiment of the present disclosure, after controlling the hot air convection heating pipe and the baking heating pipe to operate, and controlling the baking heating pipe to work for the second predetermined time length within each period, the control device is further used for: if a cooking process is not ended,

when the detection device detects that the temperature in the enamel cavity reaches a sum of the predetermined temperature and a third set value, controlling the hot air convection heating pipe and the baking heating pipe to close, and when the detection device detects that the temperature in the enamel cavity is lower than a difference between the predetermined temperature and a fourth set value, controlling the hot air convection heating pipe and the baking heating pipe to operate, and controlling the baking heating pipe to work for a third predetermined time length within each period.

In the control device for the microwave oven according to the embodiment of the present disclosure, after the baking heating pipe is controlled to work for the second predetermined time length within each period, if the temperature in the enamel cavity reaches the sum of the predetermined temperature and the third set value, the hot air convection heating pipe and the baking heating pipe are controlled to close; and if the temperature in the enamel cavity is lower than the difference between the predetermined temperature and the fourth set value, the hot air convection heating pipe and the baking heating pipe are controlled to operate, and the baking heating pipe is controlled to work for the third predetermined time length within each period, in this way, when the cooking process is not ended, the temperature in the enamel cavity can be controlled within a certain range in order to indirectly control the temperature of the outer cover of the microwave oven within the range required by the temperature standard, and thus the effective control on the temperature of the outer cover of the microwave oven is achieved.

If an instruction indicating cooking ending is received or when the cooking program is ended, it is determined that the cooking process is ended; and if the instruction indicating cooking ending is not received, and when the cooking program is not ended, it is determined that the cooking process is not ended.

According to one embodiment of the present disclosure, the first predetermined time length accounts for 40% to 60% of the predetermined period, the second predetermined time length accounts for 20% to 40% of the predetermined period, and the third predetermined time length accounts for 20% to 40% of the predetermined period; and

the first set value is 5° C. to 10° C., the second set value is 6° C. to 11° C., the third set value is 5° C. to 8° C., and the fourth set value is 2° C. to 5° C.

### BRIEF DESCRIPTION OF THE DRAWINGS

The above and/or additional embodiments of the present disclosure will become apparent and easily understood from the following description of embodiments in conjunction with the drawings, in which:

FIG. 1 shows a structural schematic diagram of a microwave oven according to an embedment of the present disclosure;

FIG. 2 shows a schematic flow diagram of a control method for a microwave oven according to one embedment of the present disclosure;

FIG. 3 shows a schematic block diagram of a control device for a microwave oven according to an embedment of the present disclosure;

FIG. 4 shows a schematic curve diagram of a temperature in a cavity of a microwave oven according to an embedment of the present disclosure;

FIG. 5 shows a schematic flow diagram of a control method for a microwave oven according to another embedment of the present disclosure.

### DETAILED DESCRIPTION

I The present disclosure will be further described in detail below in conjunction with the drawings and embodiments. It should be noted that the embodiments of the present application and the features in the embodiments can be combined with each other without conflict.

In the following description, many details are set forth in order to fully understand the present disclosure. However, the present disclosure can also be implemented in other manners than those described herein. Therefore, the scope of protection of the present disclosure is not limited to the following embodiments disclosed below.

FIG. 1 shows a structural schematic diagram of a microwave oven according to an embedment of the present disclosure.

As shown in FIG. 1, the microwave oven 1 according to the embedment of the present disclosure includes an outer cover 11, an enamel cavity 12, a hot air convection heating pipe 13 and a baking heating pipe 14 used for heating the enamel cavity 12, a temperature sensor 15 used for detecting the temperature in the enamel cavity 12, a magnetron 16 and a heat dissipating fan 17.

The control solution of the microwave oven 1 as shown in FIG. 1 will be described in detail below.

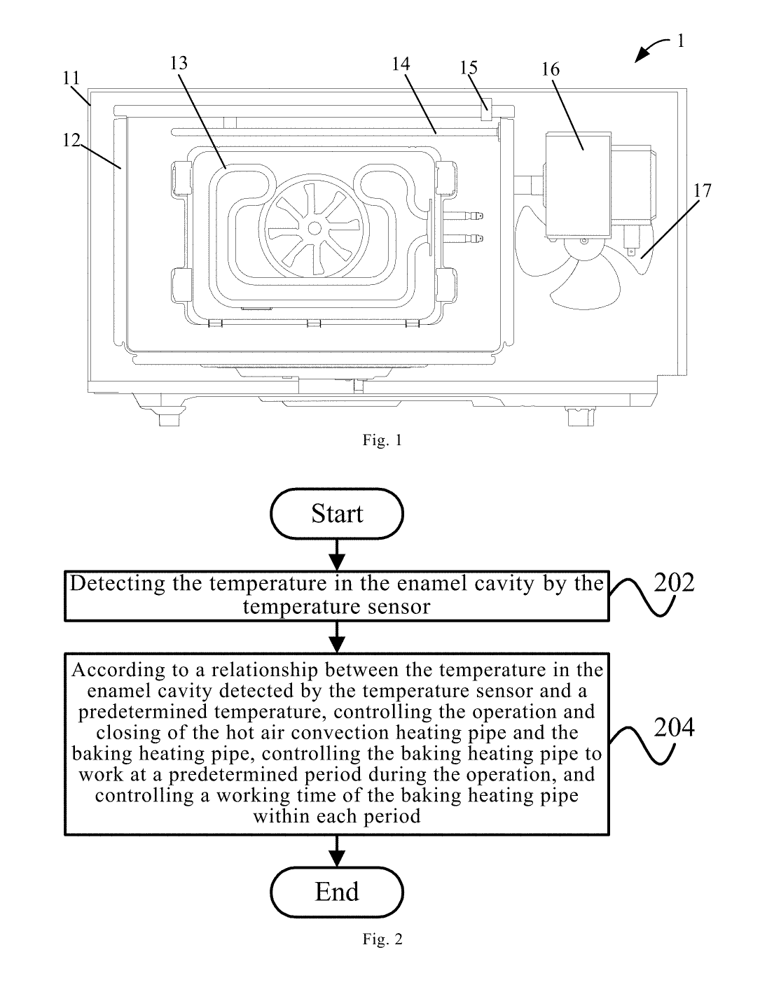

FIG. 2 shows a schematic flow diagram of a control method for a microwave oven according to one embedment of the present disclosure.

As shown in FIG. 2, the control method for the microwave oven according to one embedment of the present disclosure includes:

step 202, detecting the temperature in the enamel cavity by the temperature sensor; and

step 204, according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling a working time of the baking heating pipe within each period.

In one embodiment, for the enamel cavity microwave oven having composite functions (i.e., a hot air convection function and a baking function), by detecting the temperature in the enamel cavity, and according to the relationship between the temperature in the enamel cavity and the predetermined temperature, by controlling the operation and closing of the hot air convection heating pipe and the baking heating pipe, controlling the baking heating pipe to work at the predetermined period during the operation, and controlling the working time of the baking heating pipe within each period, on the premise of guaranteeing that the center temperature in the cavity of the microwave oven can be quickly raised, the problem that excessive temperature rise in the cavity leads to an over high surface temperature of an outer cover of the microwave oven is avoided, and effective control on the surface temperature of the enamel cavity microwave oven having the composite functions is achieved.

The control method for the microwave oven according to the above embodiment of the present disclosure can further have the following technical features:

According to one embodiment of the present disclosure, the step of controlling the operation and closing of the hot air convection heating pipe and the baking heating pipe, controlling the baking heating pipe to work at the predetermined period during the operation, and controlling the working time of the baking heating pipe within each period, includes: when an instruction of starting the microwave oven is received, controlling the hot air convection heating pipe and the baking heating pipe to operate, and controlling the baking heating pipe to work for a first predetermined time length within each period; and when the temperature in the enamel cavity reaches a difference between the predetermined temperature and a first set value, controlling the hot air convection heating pipe and the baking heating pipe to close.

When the microwave oven is just started (i.e., when the instruction of starting the microwave oven is received), the hot air convection heating pipe and the baking heating pipe are controlled to operate and the baking heating pipe is controlled to work for the first predetermined time length within each period, and when the temperature in the enamel cavity reaches the difference between the predetermined temperature and the first set value, the hot air convection heating pipe and the baking heating pipe are controlled to close, in this way, when the temperature in the cavity of the microwave oven reaches the predetermined temperature, the heating can be closed in time to avoid unnecessary temperature rise in the cavity so as to effectively control the surface temperature of the outer cover of the microwave oven. After the hot air convection heating pipe and the baking heating pipe are controlled to close, the temperature in the enamel cavity microwave oven firstly rises and then drops.

According to one embodiment of the present disclosure, after controlling the hot air convection heating pipe and the baking heating pipe to close, the method further includes: when the temperature in the enamel cavity is lower than a difference between the predetermined temperature and a second set value, controlling the hot air convection heating pipe and the baking heating pipe to operate, and controlling the baking heating pipe to work for a second predetermined time length within each period, and the second predetermined time length is shorter than the first predetermined time length.

After the hot air convection heating pipe and the baking heating pipe are controlled to close, when the temperature in the enamel cavity is lower than the difference between the predetermined temperature and the second set value, the hot air convection heating pipe and the baking heating pipe are controlled to operate, and the baking heating pipe is controlled to work for the second predetermined time length within each period, and the second predetermined time length is shorter than the first predetermined time length, in this way, after the temperature in the enamel cavity drops, the temperature in the enamel cavity can be slowly increased (since the temperature at the moment is close to the predetermined temperature) so as to effectively control the surface temperature of the outer cover of the microwave oven and avoid the problem that the temperature of the outer cover of the microwave oven is difficult to control due to the over fast temperature rise in the enamel cavity.

According to one embodiment of the present disclosure, after controlling the hot air convection heating pipe and the baking heating pipe to operate, and controlling the baking heating pipe to work for the second predetermined time length within each period, the method further includes: if a cooking process is not ended,

when the temperature in the enamel cavity reaches a sum of the predetermined temperature and a third set value, controlling the hot air convection heating pipe and the baking heating pipe to close; and when the temperature in the enamel cavity is lower than a difference between the predetermined temperature and a fourth set value, controlling the hot air convection heating pipe and the baking heating pipe to operate, and controlling the baking heating pipe to work for a third predetermined time length within each period.

After the baking heating pipe is controlled to work for the second predetermined time length within each period, if the temperature in the enamel cavity reaches the sum of the predetermined temperature and the third set value, the hot air convection heating pipe and the baking heating pipe are controlled to close; and if the temperature in the enamel cavity is lower than the difference between the predetermined temperature and the fourth set value, the hot air convection heating pipe and the baking heating pipe are controlled to operate, and the baking heating pipe is controlled to work for the third predetermined time length within each period, in this way, when the cooking process is not ended, the temperature in the enamel cavity can be controlled within a certain range in order to indirectly control the temperature of the outer cover of the microwave oven within the range required by the temperature standard, and thus the effective control on the temperature of the outer cover of the microwave oven is achieved.

If an instruction indicating cooking ending is received or when the cooking program is ended, it is determined that the cooking process is ended; and if the instruction indicating cooking ending is not received, and when the cooking program is not ended, it is determined that the cooking process is not ended.

According to one embodiment of the present disclosure, the first predetermined time length accounts for 40% to 60% of the predetermined period, the second predetermined time length accounts for 20% to 40% of the predetermined period, and the third predetermined time length accounts for 20% to 40% of the predetermined period; and

the first set value is 5° C. to 10° C., the second set value is 6° C. to 11° C., the third set value is 5° C. to 8° C., and the fourth set value is 2° C. to 5° C.

According to one embodiment of the present disclosure, the predetermined period of the baking heating pipe during the operation is 10 s to 20 s.

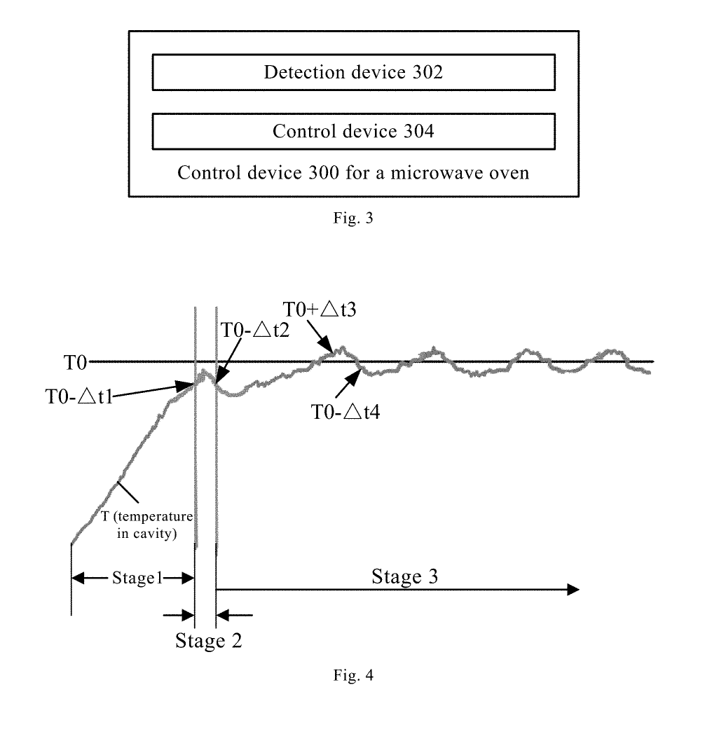

FIG. 3 shows a schematic block diagram of a control device for a microwave oven according to an embedment of the present disclosure.

As shown in FIG. 3, the control device 300 for the microwave oven according to the embedment of the present disclosure includes a detection device 302 and a control device 304.

The detection device 302 is used for detecting the temperature in the enamel cavity by the temperature sensor; and the control device 304 is used for, according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling a working time of the baking heating pipe within each period.

In one embodiment, for the enamel cavity microwave oven having composite functions (i.e., a hot air convection function and a baking function), by detecting the temperature in the enamel cavity, and according to the relationship between the temperature in the enamel cavity and the predetermined temperature, by controlling the operation and closing of the hot air convection heating pipe and the baking heating pipe, controlling the baking heating pipe to work at the predetermined period during the operation, and controlling the working time of the baking heating pipe within each period, on the premise of guaranteeing that the center temperature in the cavity of the microwave oven can be quickly raised, the problem that excessive temperature rise in the cavity leads to an over high surface temperature of an outer cover of the microwave oven is avoided, and effective control on the surface temperature of the enamel cavity microwave oven having the composite functions is achieved.

The control device 300 for the microwave oven according to the above embodiment of the present disclosure can further have the following technical features:

According to one embodiment of the present disclosure, the control device 304 is used for: when an instruction of starting the microwave oven is received, controlling the hot air convection heating pipe and the baking heating pipe to operate, and controlling the baking heating pipe to work for a first predetermined time length within each period, and when the detection device 302 detects that the temperature in the enamel cavity reaches a difference between the predetermined temperature and a first set value, controlling the hot air convection heating pipe and the baking heating pipe to close.

When the microwave oven is just started (i.e., when the instruction of starting the microwave oven is received), the hot air convection heating pipe and the baking heating pipe are controlled to operate and the baking heating pipe is controlled to work for the first predetermined time length within each period, and when the temperature in the enamel cavity reaches the difference between the predetermined temperature and the first set value, the hot air convection heating pipe and the baking heating pipe are controlled to close, in this way, when the temperature in the cavity of the microwave oven reaches the predetermined temperature, the heating can be closed in time to avoid unnecessary temperature rise in the cavity so as to effectively control the surface temperature of the outer cover of the microwave oven. After the hot air convection heating pipe and the baking heating pipe are controlled to close, the temperature in the enamel cavity microwave oven firstly rises and then drops.

According to one embodiment of the present disclosure, after controlling the hot air convection heating pipe and the baking heating pipe to close, the control device 304 is further used for: when the detection device 302 detects that the temperature in the enamel cavity is lower than a difference between the predetermined temperature and a second set value, controlling the hot air convection heating pipe and the baking heating pipe to operate, and controlling the baking heating pipe to work for a second predetermined time length within each period, and the second predetermined time length is shorter than the first predetermined time length.

After the hot air convection heating pipe and the baking heating pipe are controlled to close, when the temperature in the enamel cavity is lower than the difference between the predetermined temperature and the second set value, the hot air convection heating pipe and the baking heating pipe are controlled to operate, and the baking heating pipe is controlled to work for the second predetermined time length within each period, and the second predetermined time length is shorter than the first predetermined time length, in this way, after the temperature in the enamel cavity drops, the temperature in the enamel cavity can be slowly increased (since the temperature at the moment is close to the predetermined temperature) so as to effectively control the surface temperature of the outer cover of the microwave oven and avoid the problem that the temperature of the outer cover of the microwave oven is difficult to control due to the over fast temperature rise in the enamel cavity.

According to one embodiment of the present disclosure, after controlling the hot air convection heating pipe and the baking heating pipe to operate, and controlling the baking heating pipe to work for the second predetermined time length within each period, the control device 304 is further used for: if a cooking process is not ended,

when the detection device 302 detects that the temperature in the enamel cavity reaches a sum of the predetermined temperature and a third set value, controlling the hot air convection heating pipe and the baking heating pipe to close, and when the detection device 302 detects that the temperature in the enamel cavity is lower than a difference between the predetermined temperature and a fourth set value, controlling the hot air convection heating pipe and the baking heating pipe to operate, and controlling the baking heating pipe to work for a third predetermined time length within each period.

After the baking heating pipe is controlled to work for the second predetermined time length within each period, if the temperature in the enamel cavity reaches the sum of the predetermined temperature and the third set value, the hot air convection heating pipe and the baking heating pipe are controlled to close; and if the temperature in the enamel cavity is lower than the difference between the predetermined temperature and the fourth set value, the hot air convection heating pipe and the baking heating pipe are controlled to operate, and the baking heating pipe is controlled to work for the third predetermined time length within each period, in this way, when the cooking process is not ended, the temperature in the enamel cavity can be controlled within a certain range in order to indirectly control the temperature of the outer cover of the microwave oven within the range required by the temperature standard, and thus the effective control on the temperature of the outer cover of the microwave oven is achieved.

If an instruction indicating cooking ending is received or when the cooking program is ended, it is determined that the cooking process is ended; and if the instruction indicating cooking ending is not received, and when the cooking program is not ended, it is determined that the cooking process is not ended.

According to one embodiment of the present disclosure, the first predetermined time length accounts for 40% to 60% of the predetermined period, the second predetermined time length accounts for 20% to 40% of the predetermined period, and the third predetermined time length accounts for 20% to 40% of the predetermined period; and

the first set value is 5° C. to 10° C., the second set value is 6° C. to 11° C., the third set value is 5° C. to 8° C., and the fourth set value is 2° C. to 5° C.

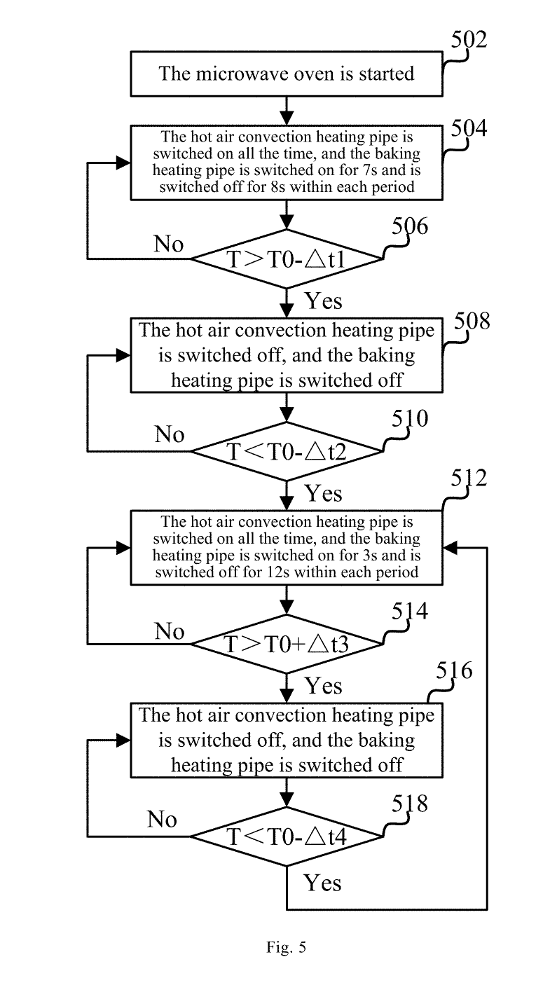

The technical solution of the present disclosure will be described in detail with reference to FIG. 4 and FIG. 5:

After the hot air convection heating pipe starts working, before reaching the set temperature T0 (e.g., 200° C.) at the center of the cavity for the first time, in order to quickly increase the temperature, a relatively high output is required, at this time, the over fast temperature rise at the center of the cavity leads to the over high surface temperature rise of the outer cover of the microwave oven, and then the temperature rise will exceed the predetermined temperature rise. Therefore, in the technical solution provided by the present disclosure, after the microwave oven starts working, before the temperature reaches the T0 for the first time, namely, when the temperature is slightly lower than T0, the hot air convection heating pipe and the baking heating pipe close the heating at the same time to effectively reduce unnecessary temperature rise, so that the surface temperature rise of the outer cover of the microwave oven is controlled.

After the temperature in the cavity reaches the set temperature T0, in order to control the temperature range of the highest point and the lowest point of the temperature in the cavity to avoid the unnecessary temperature rise, the present disclosure adopts the solution of shortening the working period of the baking heating pipe to 10 s to 20 s, in this way, the temperature range of the highest point and the lowest point of the temperature in the cavity can be controlled within an average 20° C., and the specific control logic is as shown in FIG. 4:

Stage 1: the microwave oven is started, the hot air convection heating pipe operates at full power, the baking heating pipe operates and closes according to a certain period and is switched on for 40% to 60% of the period and is switched off for 60% to 40% of the period (for example, if the period is 15 s, the baking heating pipe is switched on for 7 s and is switched off for 8 s); the temperature T of the cavity detected by the temperature sensor is compared with the set temperature T0 at the center of the cavity, and when T>T0−Δ t1, the range of Δ t1 is (5 to 10) ° C., the hot air convection heating pipe and the baking heating pipe are closed. At this time, the temperature in the cavity slightly rises and then starts dropping.

Stage 2: the temperature sensor continues to detect the temperature in the cavity and compares the detected temperature T with the set temperature T0 at the center of the cavity, when T<(T0−Δt2)° C., the range of Δt2 is (6 to 11)° C., the hot air convection heating pipe is switched on all the time, the baking heating pipe operates and closes according to a certain period and is switched on for 20% to 40% of the period and is switched off for 80% to 60% of the period (for example, if the period is 15 s, the baking heating pipe is switched on for 3 s and is switched off for 12 s). At this time, the temperature in the cavity slightly drops and then starts rising.

Stage 3: the temperature sensor continues to detect the temperature in the cavity and compares the detected temperature T with the set temperature T0 at the center of the cavity, and when T>T0+Δt3, the range of Δt3 is (5 to 8)° C., the hot air convection heating pipe is switched off, and the baking heating pipe is switched off. At this time, the temperature in the cavity slightly rises and then starts dropping. The temperature sensor continues to detect the temperature in the cavity and compares the detected temperature T with the set temperature T0 at the center of the cavity, and when T<T0−Δt4, the range of Δt4 is (2 to 5)° C., and the hot air convection heating pipe is switched on all the time, the baking heating pipe operates and closes according to a certain period and is switched on for 20% to 40% of the period and is switched off for 80% to 60% of the period (for example, if the period is 15 s, the baking heating pipe is switched on for 3 s and is switched off for 12 s). At this time, the process in the stage 3 is always circulated until the cooking is ended.

The process is as shown in FIG. 5, the control method for the microwave oven according to another embedment of the present disclosure includes:

Step 502, starting the microwave oven.

Step 504, controlling the hot air convection heating pipe to be switched on all the time, and controlling the baking heating pipe to work according to a certain period and to be switched on for 7 s and be switched off for 8 s within each period.

Step 506, judging whether the temperature T in the cavity is greater than T0−Δt1 or not, if yes, executing step 508; otherwise, returning to step 504.

Step 508, controlling the hot air convection heating pipe to be switched off, and controlling the baking heating pipe to be switched off.

Step 510, judging whether the temperature Tin the cavity is smaller than T0−Δt2 or not, if yes, executing step 512; otherwise, returning to step 508.

Step 512, controlling the hot air convection heating pipe to be switched on all the time, and controlling the baking heating pipe to work according to a certain period and to be switched on for 3 s and be switched off for 12 s within each period.

Step 514, judging whether the temperature Tin the cavity is greater than T0+Δt3 or not, if yes, executing step 516; otherwise, returning to step 512.

Step 516, controlling the hot air convection heating pipe to be switched off, and controlling the baking heating pipe to be switched off.

Step 518, judging whether the temperature Tin the cavity is smaller than T0−Δt4 or not, if yes, executing step 512; otherwise, returning to step 516.

In the technical solution of the above embodiment of the present disclosure, by adopting the control method of using the hot air convection heating pipe and the baking heating pipe together, and shortening the working period of the baking heating pipe to be within 10 s to 20 s, the problem of excessive temperature rise at the initial startup stage of the microwave oven can be effectively prevented, the center temperature and the surface temperature of an enamel microwave oven product having the composite functions (the hot air convection function and the baking function) can be effectively controlled, and the center temperature and the surface temperature meet the requirements of the temperature standard.

The technical solution of the present disclosure has been described in detail above with reference to the drawings. The present disclosure provides a novel microwave oven control solution, which can avoid the problem that excessive temperature rise in the cavity leads to the over high surface temperature of the outer cover of the microwave oven and achieves the effective control on the surface temperature of the enamel cavity microwave oven having the composite functions.

What is claimed is:

1. A method for controlling a microwave oven, wherein the microwave oven comprises an enamel cavity, a hot air convection heating pipe and a baking heating pipe for heating the enamel cavity, and a temperature sensor for detecting the temperature in the enamel cavity, the method for controlling the microwave oven comprises:
detecting the temperature in the enamel cavity by the temperature sensor; and
according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling a working time of the baking heating pipe within each period.

2. The method for controlling the microwave oven according to claim 1, wherein the step of controlling the operation and closing of the hot air convection heating pipe and the baking heating pipe, controlling the baking heating pipe to work at the predetermined period during the operation, and controlling the working time of the baking heating pipe within each period comprises:
when an instruction of starting the microwave oven is received, controlling the hot air convection heating pipe and the baking heating pipe to operate, and controlling the baking heating pipe to work for a first predetermined time length within each period; and
when the temperature in the enamel cavity reaches a difference between the predetermined temperature and a first set value, controlling the hot air convection heating pipe and the baking heating pipe to close.

3. The method for controlling the microwave oven according to claim 2, wherein after controlling the hot air convection heating pipe and the baking heating pipe to close, the method further comprises:
when the temperature in the enamel cavity is lower than a difference between the predetermined temperature and a second set value, controlling the hot air convection heating pipe and the baking heating pipe to operate, and controlling the baking heating pipe to work for a second predetermined time length within each period, wherein the second predetermined time length is shorter than the first predetermined time length.

4. The method for controlling the microwave oven according to claim 3, wherein after controlling the hot air convection heating pipe and the baking heating pipe to operate, and controlling the baking heating pipe to work for the second predetermined time length within each period, the method further comprises:
if a cooking process is not ended,
when the temperature in the enamel cavity reaches a sum of the predetermined temperature and a third set value, controlling the hot air convection heating pipe and the baking heating pipe to close; and
when the temperature in the enamel cavity is lower than a difference between the predetermined temperature and a fourth set value, controlling the hot air convection heating pipe and the baking heating pipe to operate, and controlling the baking heating pipe to work for a third predetermined time length within each period.

5. The method for controlling the microwave oven according to claim 4, wherein the first predetermined time length accounts for 40% to 60% of the predetermined period, the second predetermined time length accounts for 20% to 40% of the predetermined period, and the third predetermined time length accounts for 20% to 40% of the predetermined period; and
the first set value is from 5° C. to 10° C., the second set value is from 6° C. to 11° C., the third set value is from 5° C. to 8° C., and the fourth set value is from 2° C. to 5° C.

6. A control device for a microwave oven, wherein the microwave oven comprises an enamel cavity, a hot air convection heating pipe and a baking heating pipe for heating the enamel cavity, and a temperature sensor for detecting the temperature in the enamel cavity, the control device for the microwave oven comprises:
a detection device for detecting the temperature in the enamel cavity by the temperature sensor; and
a control device for, according to a relationship between the temperature in the enamel cavity detected by the temperature sensor and a predetermined temperature, controlling the operation and closing of the hot air convection heating pipe and the baking heating pipe, controlling the baking heating pipe to work at a predetermined period during the operation, and controlling a working time of the baking heating pipe within each period.

7. The control device for the microwave oven according to claim 6, wherein the control device is configured to:
when an instruction of starting the microwave oven is received, control the hot air convection heating pipe and the baking heating pipe to operate, and controlling the baking heating pipe to work for a first predetermined time length within each period, and
when the detection device detects that the temperature in the enamel cavity reaches a difference between the predetermined temperature and a first set value, control the hot air convection heating pipe and the baking heating pipe to close.

8. The control device for the microwave oven according to claim 7, wherein after controlling the hot air convection heating pipe and the baking heating pipe to close, the control device is further used for:
when the detection device detects that the temperature in the enamel cavity is lower than a difference between the predetermined temperature and a second set value, controlling the hot air convection heating pipe and the baking heating pipe to operate, and controlling the baking heating pipe to work for a second predetermined time length within each period, wherein the second predetermined time length is shorter than the first predetermined time length.

9. The control device for the microwave oven according to claim 8, wherein after controlling the hot air convection heating pipe and the baking heating pipe to operate, and controlling the baking heating pipe to work for the second predetermined time length within each period, the control device is further used for:
if a cooking process is not ended,
when the detection device detects that the temperature in the enamel cavity reaches a sum of the predetermined temperature and a third set value, controlling the hot air convection heating pipe and the baking heating pipe to close, and
when the detection device detects that the temperature in the enamel cavity is lower than a difference between the predetermined temperature and a fourth set value, controlling the hot air convection heating pipe and the baking heating pipe to operate, and controlling the baking heating pipe to work for a third predetermined time length within each period.

10. The control device for the microwave oven according to claim 9, wherein the first predetermined time length accounts for 40% to 60% of the predetermined period, the second predetermined time length accounts for 20% to 40% of the predetermined period, and the third predetermined time length accounts for 20% to 40% of the predetermined period; and
the first set value is from 5° C. to 10° C., the second set value is from 6° C. to 11° C., the third set value is from 5° C. to 8° C., and the fourth set value is from 2° C. to 5° C.
